(19) United States
(12) Patent Application Publication
(10) Pub. No.: US 2018/0194569 A1
(43) Pub. Date: Jul. 12, 2018

(54) TRIPPER CONNECTOR APPARATUS AND CONVEYOR APPARATUS HAVING THE SAME

(71) Applicant: FLSmidth A/S, Valby (DK)

(72) Inventor: Nicholas Tebbe, Spokane, WA (US)

(21) Appl. No.: 15/736,441

(22) PCT Filed: Jun. 15, 2016
(86) PCT No.: PCT/US16/37520

§ 371 Date: Dec. 14, 2017

Related U.S. Application Data
(60) Provisional application No. 62/175,479, filed on Jun. 15, 2015.

(51) Int. Cl. B65G 41/00; B65G 65/28

(52) U.S. Cl. CPC B65G 41/008; B65G 2201/04; B65G 65/28

(57) ABSTRACT

A mobile bridge conveyor has a frame that moveable supports it on the ground and a first moveable belt the moves to transport material. A tripper device is positioned thereon for movement along at least a portion of the frame of the mobile bridge conveyor for inclining a portion of the moveable belt of the mobile bridge conveyor. A cross conveyor having a frame that moveably supports the cross conveyor on the ground includes a second moveable belt. The tripper device is coupled to the cross conveyor via a tripper connector apparatus that moveably connects the tripper device to the frame of the cross conveyor such that the frame of the cross conveyor is moveably connected to an upper end of the tripper device such that the cross conveyor is moveable about multiple different axes via the tripper connector apparatus.

### FIELD OF INVENTION

The present invention relates to material handling More particularly, the present invention relates to a conveyor apparatus in which a mobile cross conveyor apparatus is coupled to a tripper of a mobile bridge conveyor apparatus and a connection mechanism for such a conveyor apparatus.

### BACKGROUND OF THE INVENTION

Conveyors may be used in stackers to stack material or in devices configured to reclaim material from a stack. Typically, systems designed for stacking and reclaiming material utilize a number of conveyors. One set of conveyors is typically used to convey material to a stacker for stacking in a particular area. Another set of conveyors is used to reclaim the material stacked in that area. Examples of systems used to stack material or reclaim material and/or devices utilized in such systems are disclosed in U.S. Pat. Nos. 8,534,443, 8,376,125, 8,348,044, 8,276,736, 8,251,199, 6,782,993, 6,085,890, 5,609,397, 5,562,194, 5,090,549, 4,139,087, 3,604,757, 2,851,150 and 1,996,488, and U.S. Patent Application Publication Nos. 2009/0095595 and 2007/0102263. In addition to conveyors, other devices are typically used in stacking and reclamation systems. For instance, a stacker is typically used to stack material transported by a stacking conveyor system. Examples of stackers are disclosed in U.S. Pat. Nos. 3,297,141, 3,653,486, 4,319,677, 4,406,361, 4,629,060, 6,360,876, and 6,896,123.

U.S. Pat. Nos. 8,348,044 and 8,251,199 disclose a material transport system that includes a mobile bridge conveyor having a tripper device and a mobile cross conveyor that are positionable adjacent to each other and are moveable adjacent to each other to facilitate material handling operations. U.S. Pat. Nos. 8,348,044 and 8,251,199 also disclose a controller and sensors that are utilized to help ensure alignment of the cross conveyor with the tripper device of the mobile bridge conveyor.

A conveying system is also disclosed in U.S. Pat. No. 7,191,888, which discloses a mobile bridge conveyor and a separate tripper that is moveable relative to the mobile bridge conveyor. The moveable tripper includes a traveling tripper conveyor and a tipping bridge conveyor. The mobile bridge conveyor and the traveling tripper conveyor share a conveyor belt that travels from the bridge conveyor to the traveling tripper frame. The system disclosed in U.S. Pat. No. 7,191,888 requires the tripper to have a frame that is separate from the bridge conveyor that supports the tripper conveyor and the tipping bridge conveyor, which may also be referred to as a cross conveyor. The tripper may be moved relative to the bridge conveyor to adjust the position of the tripper conveyor and cross conveyor. The position of the mobile bridge conveyor and separate tripper may be adjusted relative to a feed conveyor. To make such an adjustment, the conveyor belt shared by the mobile bridge conveyor and the tripper conveyor of the tripper must be slackened. The slackening of the belt is necessary to avoid belt misalignment that may occur. As a practical matter, the slackening of the shared belt requires operations supported by the mobile bridge conveyor and tripper to be stopped or an auxiliary unit to be operational during this movement. Either alternative incurs significant costs associated with an auxiliary system or the temporarily ceased operations.

I have determined that a new conveyor apparatus is needed to help reduce costs associated with the manufacture and operation of material handling systems and devices utilized in such systems.

### SUMMARY OF THE INVENTION

A conveyor apparatus is provided that can include a mobile bridge conveyor having a first frame that is attached to at least one first moveable member such that the first frame is moveable along ground and a first belt moveably connected to the first frame for movement along a path of travel that is at least partially supported by the first frame. The first frame can have a first end and a second end opposite the first end. The first belt can be moveable to convey material in at least one direction. A cross conveyor having a second frame attached to at least one second moveable member such that the second frame is movable along the ground can also be included in the apparatus. The cross conveyor can include a second belt that is moveably attached to the second frame. The second belt can be moveable for conveying material in at least one direction. A tripper device can be moveably attached to the first frame of the mobile bridge conveyor such that the tripper device is moveable between the first end and the second end of the first frame. An upper end of the tripper device can also be moveably attached to the second frame of the cross conveyor via a tripper connector apparatus such that the cross conveyor is rotatable about at least one substantially vertical axis relative to the upper end of the tripper device and the cross conveyor is tiltable about at least one substantially horizontal axis relative to the tripper device.

Embodiments of the conveyor apparatus can be configured so that the tripper device is moveably attached to the first frame of the mobile bridge conveyor such that the path of travel the first belt moves about comprises a first inclined path segment extending from adjacent the first frame to the upper end of the tripper device and a second declined path segment that extends from the upper end of the tripper device to adjacent the first frame. The first and second path segments can be defined by the tripper device. The first belt can move along the first and second path segments as the first belt is moved from the first end of the first frame to the second end of the first frame to transport material.

The tripper connector apparatus can be structured in different ways. For instance, some embodiments of the tripper connector apparatus can include a first connection between the upper end of the tripper device and the second frame of the cross conveyor, a second connection between the upper end of the tripper device and the second frame of the cross conveyor, and a third connection between the upper end of the tripper device and the second frame of the cross conveyor. The first connection can be defined by at least one first pin defining a first substantially horizontal axis of rotation about which the cross conveyor is moveable relative to the upper end of the tripper device. The second connection can be defined by at least one second pin defining a second substantially horizontal axis of rotation about which the cross conveyor is moveable relative to the upper end of the tripper device. The second substantially horizontal axis can be substantially perpendicular to the first substantially horizontal axis. The third connection can be defined by a rotatable connector such that the cross conveyor is moveable relative to the upper end of the tripper device about a substantially vertical axis that is substantially perpendicular to the first and second substantially horizontal axes. In some embodiments, the first substantially horizontal axis is a linear axis that is inclined or declined between 0° and 10°, the second substantially horizontal axis is a linear axis that is inclined or declined between 0° and 10°, and the substantially vertical axis is a linear axis that is inclined or declined relative to the ground between 80° and 100°. The rotatable connector of the third connection can be comprised of a slew ring in some embodiments of the apparatus

In some embodiments of the tripper connector apparatus, the first substantially horizontal axis is a horizontal axis, the second substantially horizontal axis is a horizontal axis that is transverse to the first horizontal axis, and the substantially vertical axis is a vertical axis that is perpendicular to the first and second horizontal axes. In some embodiments, the first substantially horizontal axis defined by the at least one first pin extends in a direction that is perpendicular to the direction at which the second substantially horizontal axis defined by the at least one second pin extends. The first substantially horizontal axis can be defined by a single first pin or a plurality of first pins and the second substantially horizontal axis can be defined by a single second pin or a plurality of second pins.

Embodiments of the conveyor apparatus can also include at least one first sensor attached to one of the cross conveyor and the tripper device and at least one second sensor attached to the tripper device and at least one controller communicatively connected to the first and second sensors. A first adjustment mechanism having a moveable leg attached between the second frame of the cross conveyor and the upper end of the tripper device can also be included in embodiments of the conveyor apparatus. The moveable leg can be moveable to adjust a position of the upper end of the tripper device for centering the upper end of the tripper device relative to the first frame. The controller can be communicatively connected to the first adjustment mechanism to actuate movement of the moveable leg based on data the controller receives from the first and second sensors.

In some embodiments, the first and second sensors can include sensors attached to the tripper device. For instance, the tripper device can be comprised of a tripper device frame having a first set of wheels attached to the first frame and a second set of wheels attached to the first frame. Each first sensor can be attached to the first set of wheels and each second sensor can be attached to the second set of wheels. The tripper device can also include at least one member extending from each second set of wheels to a position adjacent the upper end of the tripper device and a third sensor can be attached to each member extending from the second set of wheels to adjacent the upper end of the tripper device. Each third sensor can be communicatively connected to the controller. The controller can be configured to actuate movement of the moveable leg based on data the controller receives from the first and second sensors and each third sensor.

A tripper connector apparatus for moveably attaching a cross conveyor to a tripper device of a mobile bridge conveyor is also provided. The tripper connector apparatus can include a first connection between the tripper device positioned on a frame of the mobile bridge conveyor and the cross conveyor, a second connection between the tripper device and the cross conveyor, and a third connection between the tripper device and the cross conveyor. The first connection can be defined by at least one first pin defining a first substantially horizontal axis of rotation about which the cross conveyor is moveable relative to an upper end of the tripper device. The second connection can be defined by at least one second pin defining a second substantially horizontal axis of rotation about which the cross conveyor is moveable relative to the upper end of the tripper device. The second substantially horizontal axis can be substantially perpendicular to the first substantially horizontal axis. The third connection can be defined by a rotatable connector such that the cross conveyor is rotatable relative to the upper end of the tripper device about a vertical axis that is substantially perpendicular to the first and second substantially horizontal axes.

In some embodiments, the rotatable connector of the third connection can comprise a slew ring.

It is contemplated that first substantially horizontal axis can be defined by a single first pin and the second substantially horizontal axis is defined by a single second pin in some embodiments of the tripper connector apparatus. In other embodiments, multiple first pins that are spaced apart from each other and aligned with each other can define the first substantially horizontal axis and multiple second pins that are spaced apart from each other and aligned with each other can define the second substantially horizontal axis. In some embodiments, the first substantially horizontal axis can extend in a direction that is perpendicular to the direction at which the second substantially horizontal axis extends. The first substantially horizontal axis can be a horizontal axis, the second substantially horizontal axis can be a horizontal axis, and the substantially vertical axis can be a vertical axis that is perpendicular to the first and second horizontal axes. In some embodiments, the first substantially horizontal axis is a linear axis that is inclined or declined between 0° and 10°, the second substantially horizontal axis is a linear axis that is inclined or declined between 0° and 10°, and the substantially vertical axis is a linear axis that is inclined or declined relative to the ground between 80° and 100°.

A conveyor apparatus is also provided that includes a mobile bridge conveyor having a first frame that is attached to at least one first moveable member such that the first frame is moveable along ground and a first belt that is at least partially supported by the first frame. The first frame has a first end and a second end opposite the first end. The first belt can be moveable to convey material in at least one direction. A tripper device can be moveably attached to the first frame of the mobile bridge conveyor such that the tripper device is moveable between the first end and the second end of the first frame and the first belt of the mobile bridge conveyor is moveable about a portion of the tripper device. A cross conveyor having a second frame attached to at least one second moveable member such that the second frame is movable along the ground can also be included in the conveyor apparatus. The second belt can be moveably attached to the second frame. The second belt can be moveable for conveying material in at least one direction. The second frame of the cross conveyor can be attached to an upper end of the tripper device via a tripper connector apparatus. The conveyor apparatus can also include at least one first sensor attached to one of the tripper device and the cross conveyor and at least one second sensor attached to the tripper device and at least one controller communicatively connected to the first and second sensors. A tripper adjustment mechanism can also be attached between the second frame of the cross conveyor and the upper end of the tripper device to moveably adjust a position of the upper end of the tripper device for centering the tripper device relative to the first frame. The controller can be communicatively connected to the tripper adjustment mechanism to actuate movement of at least one moveable leg of the tripper adjustment mechanism based on data the controller receives from the first and second sensors for centering the tripper device relative to the first frame.

In some embodiments, the tripper adjustment mechanism can also include a roller table or sliding table that facilitates movement of an upper end of the tripper device to center the upper end of the tripper device with the first frame. The roller table or sliding table can include rollers or other moveable elements that are attached to the second frame of the cross conveyor and are also connected to the upper end of the tripper device such that the upper end of the tripper device is moveable along a length of the second frame so that it can be centered, or otherwise positioned into alignment with the first frame to maintain alignment of the first belt (e.g. help ensure that the first belt stays aligned and does not become misaligned).

In some embodiments of the conveyor apparatus, the tripper connector apparatus can include a first connection between the tripper device and the cross conveyor, a second connection between the tripper device and the cross conveyor, and a third connection between the tripper device and the cross conveyor. The first connection can be defined by at least one first pin defining a first substantially horizontal axis of rotation about which the cross conveyor is moveable relative to the tripper device and the second connection can be defined by at least one second pin defining a second substantially horizontal axis of rotation about which the cross conveyor is moveable relative to the tripper device. The second substantially horizontal axis can be transverse to the first substantially horizontal axis. The third connection can be defined by a rotatable connector such that the cross conveyor is rotatable relative to the upper end of the tripper device about a vertical axis that is substantially perpendicular to the first and second substantially horizontal axes. The at least one first moveable member can be comprised of a plurality of tracks or crawlers and the at least one second moveable member can be comprised of a plurality of tracks or crawlers.

Other details, objects, and advantages of the invention will become apparent as the following description of certain present preferred embodiments thereof and certain present preferred methods of practicing the same proceeds.

### BRIEF DESCRIPTION OF THE DRAWINGS

Exemplary embodiments of a conveyor apparatus and a tripper connector apparatus are shown in the accompanying drawings and certain exemplary methods of practicing the same are also illustrated therein. It should be understood that like reference numbers used in the drawings may identify like components.

FIG. 1 is a side view of a first exemplary embodiment of a conveyor apparatus.

FIG. 2 is a fragmentary side view of the first exemplary embodiment of the conveyor apparatus.

FIG. 3 is an end view of the first exemplary embodiment of the conveyor apparatus.

FIG. 4 is an enlarged fragmentary end view of the first exemplary embodiment of the conveyor apparatus illustrating a tripper connector apparatus of the first exemplary embodiment of the conveyor apparatus.

FIG. 5 is an enlarged fragmentary side view of the first exemplary embodiment of the conveyor apparatus illustrating the tripper connector apparatus of the first exemplary embodiment of the conveyor apparatus.

FIG. 6 is a flow chart illustrating an exemplary method for determining when to actuate adjustment of an upper end of the tripper device of the first exemplary embodiment of the conveyor apparatus.

### DETAILED DESCRIPTION OF EXEMPLARY EMBODIMENTS

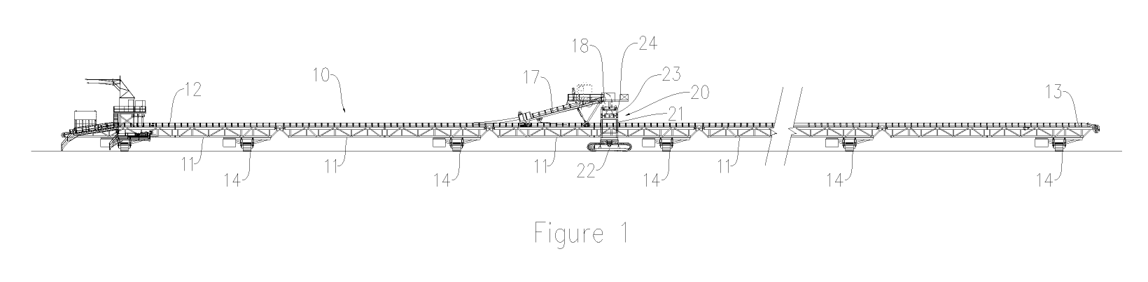

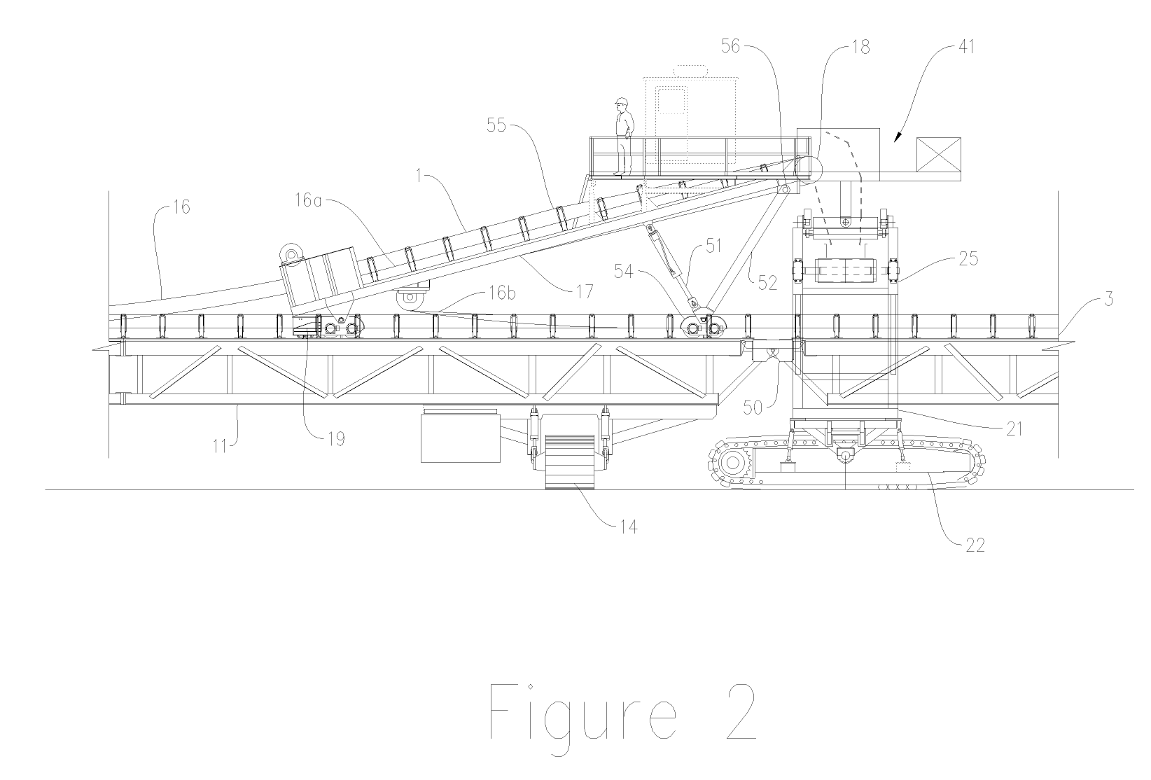

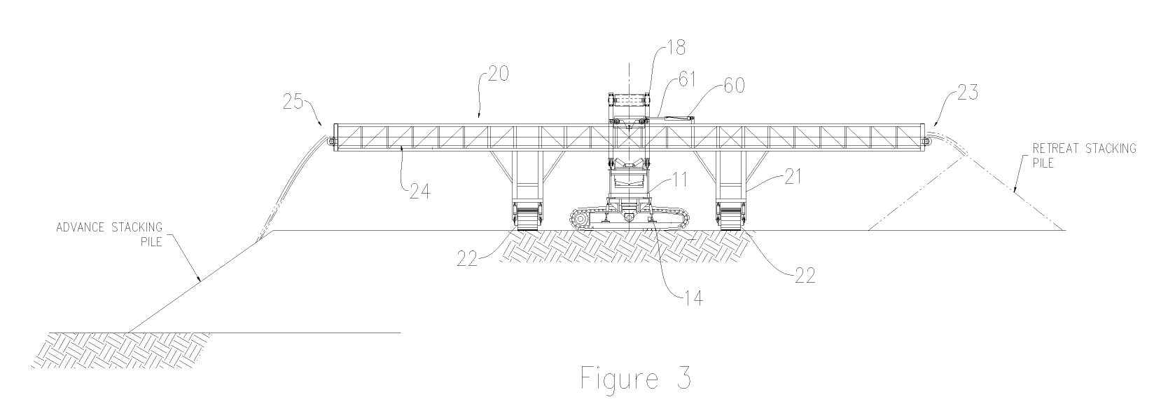

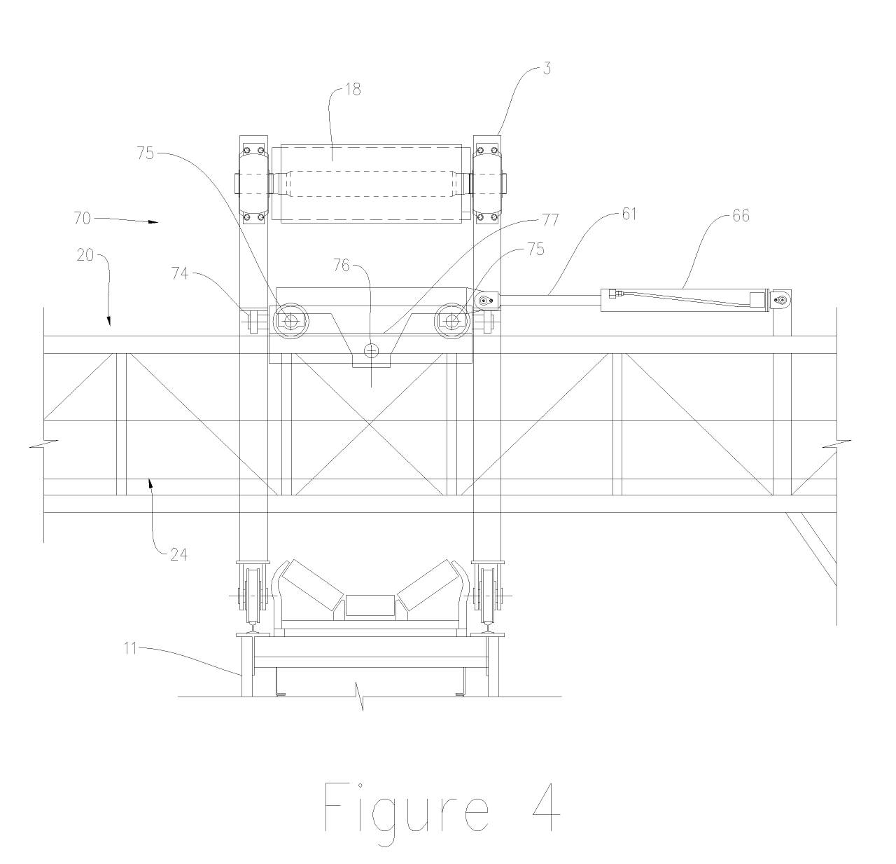

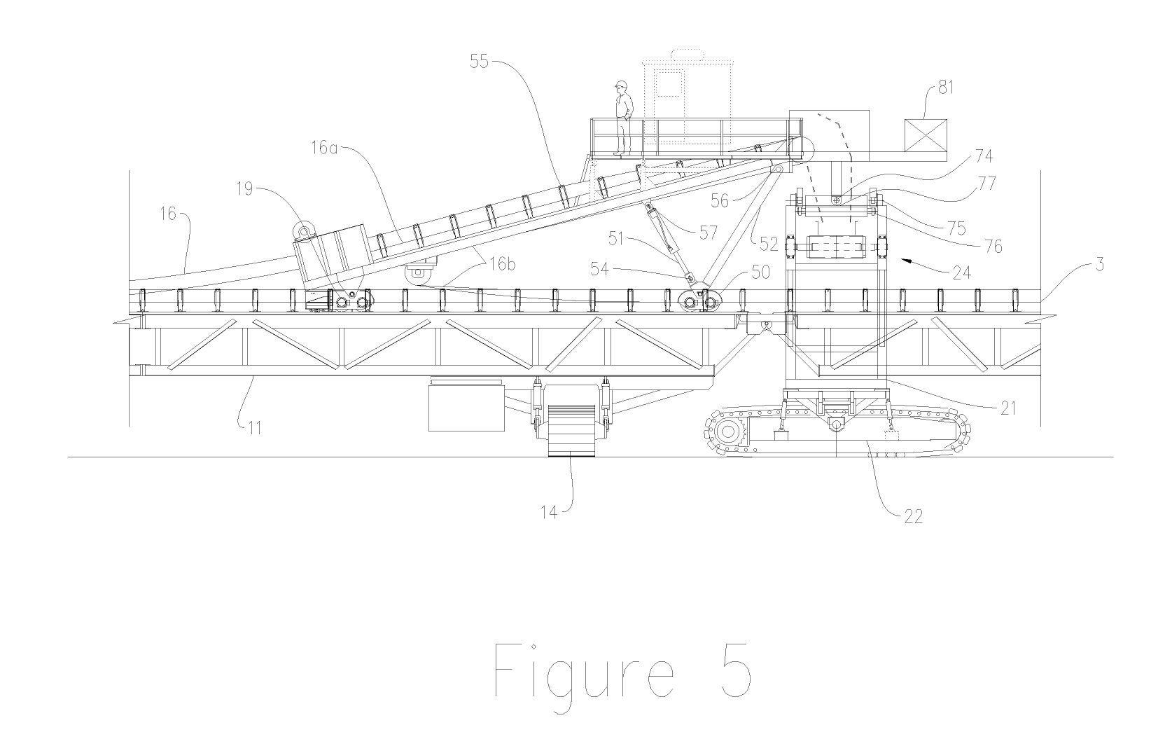

Referring to FIGS. 1-5, a conveyor apparatus 1 may include a mobile bridge conveyor 10 and a cross conveyor 20. The mobile bridge conveyor 10 may receive material for transport from an overland conveyor or other source and feed that material to the cross conveyor 20 for stacking via a tripper device 17 positioned on the mobile bridge conveyor 10. The cross conveyor 20 may receive that material and deposit that material in a storage pile in a designate area or transfer that material to another bridge conveyor, a hopper, or other device. The storage pile could be one of an advance stacking storage pile and a retreat stacking storage pile which may be on opposite sides of the cross conveyor 20.

The mobile bridge conveyor 10 can include a first frame 11 that is attached to multiple tracks 14 or other moveable members that moveably support the first frame 11 on ground. In some embodiments, the tracks 14 could be considered crawlers. The first frame 11 may support a moveable first belt 16. The first belt 16 may be a continuous belt that travels from around a first end 12 of the first frame 11 to a second end 13 that is opposite the first end 12. The first frame 11 may include a plurality of spaced apart idlers that support a first belt 16 that is moveable in at least one direction to transport material along the first belt 16.

In some embodiments, the first belt 16 may be moveable in a first direction from the first end 12 to the second end 13. In some embodiments, the first belt 16 may only be moveable in one direction. It is contemplated that this may not always be the case. For instance, it is contemplated that some embodiments could be configured so that the belt 16 is also configured to be moveable in a second direction from the second end 13 to the first end 12. An actuator (e.g. a hydraulic cylinder or other actuator) can maintain alignment of the first belt 16 as it moves along a path at least partially defined by the first frame 11. An actuator coupled to a head pulley of the first frame about which the first belt moves around can be actuated to adjust the position of the head pulley so that the first belt is straight. The actuator can be actuated to maintain the position of the head pulley is centered over the mobile bridge conveyor so that the first belt does not wander toward one side of the first frame or otherwise becomes misaligned. A controller can be connected to the actuator to cause the actuator to move to adjust the position to the head pulley as necessary to center the head pulley.

The first belt 16 may move about the first frame 11 and tripper device 17 along a path that include a first inclined path portion 16a that extends from the first frame 11 over a tripper device 17 along an inclined path segment and a second portion 16b that extends along a declined path segment from the upper end pulley 18 of the tripper device 17 back to trough idlers or other idlers supported by the first frame 11. The first belt 16 may move along the first and second path portions 16a and 16b when the first belt 16 is moved from the first end 12 to the second end 13 for transporting material.

The tripper device 17 may have a frame that includes a lower end that is adjacent the first frame 11 and an upper end that has a terminal, upper end pulley 18. The first belt 16 may move from the lower end of the tripper device 17 to the upper end pulley 18 to transport material onto a moveable second belt 24 of the cross conveyor 20. The tripper device 17 may be moveably connected to rails of the first frame 11 via a plurality of moveable carriages for movement along the rails of the first frame 11. A first set of moveable carriages 19 may be attached to a frame of the tripper device that helps define the first and second path segments 16a, 16b along the path of movement of the first belt 16. The tripper device 17 may also include a second set of carriages 50 attached to the tripper device frame below an upper end of the tripper device. The second set of carriages 50 can also be configured to roll along the rails of the first frame 11.

The first and second moveable carriages 19, 50 may include one or more wheels or other elements that permit the tripper device 17 to be moved, rolled, or slid along rails along the upper portion of the frame 11 of the mobile bridge conveyor. The rails of the frame may laterally constrain the tripper device 17 onto the first frame 11. Movement of the tripper device 17 can permit a location of the raised upper end of the tripper device to be located along a length of the first frame 11 and can permit the first inclined path segment 16a and second declined path segment 16b of the first belt to be selectively positioned along a length of the first frame 11 of the mobile bridge conveyor that extends between the first and second ends 12, 13 of the first frame 11.

The frame of the tripper device 17 can be configured such that the second set of carriages 50 are not load bearing or at least do not bear a significant portion of the weight of the tripper device 17 (e.g. bear and/or convey 5% or less than 5% of the weight of the tripper device on the first frame 11 of the mobile bridge conveyor 10). The frame of the tripper device 17 may be configured so that only the first set of moveable carriages 19 support the tripper device 17 on the first frame 11 of the mobile bridge conveyor 10 and that only a tripper connector apparatus 70 connects the tripper connector apparatus 70 to a cross conveyor 20 so that the cross conveyor 20 also supports a portion of the weight of the tripper device 17 such that the entire weight of the tripper device 17 or a substantial portion of the weight of the tripper device (e.g. 90-100% of the weight of the tripper device 17) is only supported by (i) the first frame 11 of the mobile bridge conveyor 10 via the first set of moveable carriages 19 and (ii) the frame of the cross conveyor 20 via joint defined by the tripper connector apparatus 70 that connects the tripper device 17 to the cross conveyor 20.

Further, the size and costs associated with fabricating the mobile bridge conveyor 10 can be reduced relative to conventional conveyors due to the weight of the tripper device 17 being distributed over two different, separate conveyors, the mobile bridge conveyor 10 and the cross conveyor 20. As a result of the sharing of the load between these two separate devices, the size and weight of the first frame can be drastically reduced. This can provide substantial cost savings associated with fabrication of the mobile bridge conveyor 10.

The amount of the load (e.g. weight) of the tripper device 17 that is distributed between the mobile bridge conveyor 10 and the cross conveyor 20 can be controlled by positioning of a counterweight 81. A controller can actuate motion of the counter weight 81 to more precisely control the load of the tripper device 17 supported by the first frame 11 of the mobile bridge conveyor 10 as well as the load supported by the second frame 21 of the cross conveyor 20 in response to load cells on tripper wheels 19 and/or load cells on the tripper connector apparatus 70 such that the counter weight 81 can be moved to a desired position in view of the loads on the tripper wheels 19 and/or the tripper connector apparatus 70. The load cells can be sensors or other type of detector that communicates data relating to the loads on the tripper wheels 19 and/or the tripper connector apparatus 70. The controller can be communicatively connected to the load cells to receive that data and actuate movement of the counterweight based on that received data.

The cross conveyor 20 is a device that can be separated from the mobile bridge conveyor 10. The cross conveyor 20 can be moveable independent of the mobile bridge conveyor 10 so that the cross conveyor 20 is moveable along ground relative to the mobile bridge conveyor 10 and independent of the mobile bridge conveyor 10. The cross conveyor 20 includes its own second frame 21 that may support the weight of the cross conveyor 20. The cross conveyor 20 also includes multiple tracks 22 or other moveable elements that support the second frame 21 of the cross conveyor 20 on the ground and permit the cross conveyor 20 to move along the ground. The tracks 22 in some embodiments may be crawlers or tires. The cross conveyor 20 also include the second belt 24 that is supported on the second frame 21. The second frame 21 may include a plurality of idlers that define a path of movement for the second belt 24 that extends from a first end 23 to a second end 25 of the second frame 21 in a continuous loop or continuous path about which the second belt 24 moves for conveying material. Each terminal end of the portion of the second frame 21 defining the path of motion for the second belt 24 may include a pulley for the continuous second belt 24 to move to transport material along a length of the belt path defined between the first and second ends 23, 25 of the second frame 21 of the cross conveyor 20. The second frame 21 of the cross conveyor 20 may include a leveling system that is configured to adjust the position of the second belt 24 so that the second belt 24 is supported in a desired orientation (e.g. a level orientation or a slightly inclined orientation) while the cross conveyor moves over non-level ground (e.g. inclined or declined ground).

The second belt 24 may be moved for stacking material in a pile. For instance, material may be moved toward the first end 23 of the second belt 24 so that the material is discharged off a first end 23 of the second frame 21 of the cross conveyor 20 that supports the second belt 24 to stack material such as ore, coal, rock, stone, or other material in a storage area. The second belt 24 may be configured to move in only one direction or in two opposite directions. For example, the second belt can be configured to move in a first direction so that the second belt 24 moves from the second end 25 to the first end 23 for transporting material towards the first end 23. The second belt 24 may also move from the first end 23 to the second end 25 for transporting material toward the second end 25.

The second frame 21 of the cross conveyor 20 may be configured so that the frame is able to straddle the moveable bridge conveyor 10. For instance, tracks 22 may be on opposite sides of the first frame 11 of the moveable bridge conveyor 10. In other embodiments, the second frame 21 of the cross conveyor 20 may be configured so that the tracks of the cross conveyor 20 are only located on one side of the first frame 11 of the moveable bridge conveyor 10 and only the second belt 24 and a portion of the frame 21 of the cross conveyor 20 extends over the first frame 11 of the moveable bridge adjacent to the tripper device and below an upper end of the tripper device 17 for receiving material from the first belt 16 for transporting the material to a pile.

When the second frame 21 straddles the first frame 11, the second belt 24 may extend in a direction that is substantially perpendicular (e.g. within 0°-10° or 0°-5° of being perpendicular) to the direction in which the first belt 16 extends along the first frame 11 as may be appreciated from FIGS. 1-5. Additionally, when the cross conveyor 20 is positioned so that second belt 24 can receive material from the upper end of the tripper device 17 for transporting material, the direction of movement of the second belt 24 may be perpendicular or substantially perpendicular (e.g. within 10° of being perpendicular) to a direction of movement of the first belt 16.

Movement of the moveable bridge conveyor 10 and cross conveyor 20 along the ground via tracks 14 and 22 for positioning of the first and second belts 16, 24 for material transport operations may be controlled by at least one controller communicatively connected to the tracks 22 and 14 and a plurality of sensors attached to the moveable bridge conveyor 10 and cross conveyor 20 for actuating movement of the tracks 22 and 14 for moving the moveable bridge conveyor 10 and cross conveyor 20. The controller may be attached to the mobile bridge conveyor or the cross conveyor or may be in a position remote to those devices.

For example, a controller having at least one processor, at least one transceiver connected to the processor, and non-transitory memory connected to the processor, may be communicatively connected to the conveyor apparatus 1 and global positioning system (“GPS”) sensors or other location sensors attached to each end of the frame 21 of the cross conveyor adjacent the first end 23 and second end 25. The controller may also be communicatively connected to the mobile bridge conveyor 10 and sensors attached to the mobile bridge conveyor 10 and to the tripper device 17 and sensors attached to the tripper device 17. The mobile bridge conveyor 10 may also include at least one GPS sensor on the first and second ends 12, 13 of the mobile bridge conveyor 10 and at the upper end of the tripper device 17 moveably attached to the frame 11 of the mobile bridge conveyor 10. The GPS sensors may be connected to the controller via a wireless connection or some other communication connection mechanism permitting the sensors to transmit data to the controller.

The controller may include a processing unit such as a microprocessor or central processing unit and non-transitory memory such as a hard drive or flash memory that has software run by the processing unit. The controller could be, for example, a work station, a programmable logic controller, or other type of controller computer device. The software run by the controller can be configured so that the controller is able to determine when the cross conveyor 20 or mobile bridge conveyor 10 is positioned beyond a predefined allowable distance from the other device and cause one or both of the devices to move to adjust the position of the devices to within a predefined tolerable position. For example, the controller may be configured to run software stored thereon for the processor to run that software. The controller may be configured so that the cross conveyor 20 is moved relative to and independent of the mobile bridge conveyor 10 when the mobile bridge conveyor 10 is stationary. The controller may be configured such that a position of an end of the cross conveyor 20 that is determined via a position of that end measured by a GPS sensor. If the position is determined to be a predefined distance away from a portion of the mobile bridge conveyor 10, the controller can be configured to cause the cross conveyor 20 to move to readjust its position relative to the mobile bridge conveyor 10 to be within this predefined distance.

The predefined distance may be measured from a GPS sensor located on the mobile bridge conveyor or the controller may be configured to measure the predefined distance based on a center line or other position that is determined based on the location of different GPS sensors located on the mobile bridge conveyor. For instance, a GPS sensor on each end of the mobile bridge conveyor may define two end points of a line that is determined by the controller. When an end of the cross conveyor 20 (e.g. first end 23 or second end 25) is determined to be a predefined distance from this line via the GPS sensor attached to that end of the cross conveyor, the controller may be configured to cause the cross conveyor 20 to move to readjust its position relative to the mobile bridge conveyor 10. The distance may be measured as a straight line distance from the line or may be measured as a distance relative to a centered mid point or non-centered mid point of the line.

The controller can also be configured to make the mobile bridge conveyor 10 a slave to the location or position of the cross conveyor 20. For example, the controller can be configured to determine if the location of the tripper device 17 is too close to an end of a cross conveyor 20. If the controller determines via a GPS sensor on the tripper device 17 that the tripper device 17 is within a predefined distance from an end of the cross conveyor 20, the controller can be configured to cause the mobile bridge conveyor 10 to move to readjust the position of at least a portion of the mobile bridge conveyor 10 relative to the cross conveyor 20 such that the tripper device 17 is repositioned farther than the predefined distance from that end of the cross conveyor 20. Such readjustment may occur while both the mobile bridge conveyor 10 and the cross conveyor 20 are each moving.

The controller can also be configured to determine a line between end points defined by the location of the first and second ends 23, 25 of the cross conveyor 20 via the GPS sensors attached to those ends of the cross conveyor. When a GPS sensor attached to an upper end of the tripper device 17 is determined to be a predetermined distance from this line, the controller can be configured to cause a portion of the mobile bridge conveyor 10 to move to straighten the mobile bridge conveyor 10. The predetermined distance or amount may be defined by a pre-specified tolerance range.

The controller may also be configured to adjust from a first configuration to a second configuration. For example, the controller may be configured to adjust from a configuration in which the cross conveyor 20 is slaved to the mobile bridge conveyor 10 to a configuration in which the position of the mobile bridge conveyor 10 is slaved to the position of the cross conveyor 20. An input device, a button or an actuator may be connected to the controller such that an operator may manipulate the input device, button or actuator to adjust the configuration of the controller. For example, a key pad, key board, input device, or other actuation mechanism may be connected to the controller such that the operator can also provide other input to the controller. A display device may also be connected to the controller such that the controller can transmit output to the display device for displaying the output to the operator.

The controller may also be configured to cause the second belt 24 of the cross conveyor 20 to move while the mobile bridge conveyor 10 and cross conveyor 20 are moving via movement of tracks 14 and 22. Such movement may occur while material is being stacked to ensure the material is stacked in a straight pile. For instance, movement or repositioning of the cross conveyor 20 and the mobile bridge conveyor 10 away from a stacked pile may cause the controller to cause an end of the frame of the cross conveyor to extend outward toward the stacked pile to ensure the material being stacked is stacked in a straight pile even when the cross conveyor 20 and the mobile bridge conveyor 10 are being moved or repositioned. As another example, the controller can be configured to cause the cross conveyor to retract or move away from the stacked pile to ensure the material being stacked is stacked in a straight pile even when the cross conveyor 20 and the mobile bridge conveyor 10 are being moved or repositioned.

I have determined that a coupling device may be utilized for coupling the upper end of the tripper device 17 to the second frame 21 of the cross conveyor 20. I have determined that such a coupling device can help mechanically align the material transfer point between the tripper device 17 and the cross conveyor 20 that is adjacent the upper end pulley 18 of the tripper device 17. Such a mechanical alignment can provide a precise and reliable alignment mechanism.

The coupling device can be configured to provide freedom of motion between the cross conveyor 20 and the tripper device 17 as well as providing a freedom of motion between the cross conveyor 20 and the mobile bridge conveyor 10. Such freedom of motion can help the cross conveyor 20 maneuver even though it is coupled to the mobile bridge conveyor 10 via its mechanical connection to the mobile bridge conveyor 10 via the coupling device mechanically connecting the cross conveyor 20 to the tripper device 17 supported on the mobile bridge conveyor 10. For instance, the coupling device can be configured to permit the cross conveyor 20 to turn so that one of the cross conveyor tracks advances ahead of the other such that the cross conveyor 20 moves at an angle relative to the mobile bridge conveyor 10 and tripper device 17. Such a freedom of motion provided by the coupling device can permit the cross conveyor 20 to correct its position over the mobile bridge conveyor 10.

As another example, the coupling device can be configured to permit the second frame 21 of the cross conveyor to tilt with respect to the mobile bridge conveyor 10 and tripper device 17 even though the cross conveyor 20 is mechanically coupled to the tripper device 17 and the coupling device mechanically aligns the upper end of the tripper device with the cross conveyor 20 and second belt 24 of the cross conveyor 20. Such tilting can permit the cross conveyor to travel up an inclined path or down a declined path so that the second belt 24 can be positioned so that it is level or only slightly inclined or slightly declined during such motion of the cross conveyor so that material does not fall off of the second belt 24 in an undesirable way prior to material being output from an end of that belt to a pile of material. Such tilting can also be helpful as it can permit the cross conveyor 20 to be at different tilted positions that may result from the leveling system of the second frame 21 of the cross conveyor 20 moving to account for a grade or level of inclination or declination of the ground about which the cross conveyor is moving that results in one crawler being at a different height than another crawler of the cross conveyor 20. The tilting provided by the coupling device can also permit tilting of the second belt 24 provided by the second frame 21 to occur while the cross conveyor is mechanically coupled to the tripper device 17 that may result from motion of second frame 21 that is within a tolerance range of the cross conveyor leveling system while the cross conveyor moves along a flat ground surface, an inclined ground surface, or a declined ground surface. The rotatable and tilting connection that can be provided by the coupling device can also permit the cross conveyor 20 to move closer or farther from the mobile bridge conveyor 10. For a straddling cross conveyor 20 that straddles the mobile bridge conveyor by having at least one crawler on opposite sides of the mobile bridge conveyor while having the second belt 24 positioned below the upper end pulley 18 of the tripper device to receive material from the first belt, the this motion can also permit one side of the cross conveyor 20 to get closer to the mobile bridge conveyor while the opposite side moves farther away from the mobile bridge conveyor 10.

An embodiment of my coupling device is a tripper connector apparatus 70 that may be configured to couple an upper end portion of the tripper device 17 to the second frame 21 of the cross conveyor 20. In one contemplated embodiment, the tripper connector apparatus 70 may be configured as a shoulder joint connecting the tipper device 17 to the second frame 21 of the cross conveyor 20. In other embodiments, the tripper connector apparatus may be configured as a combination of a gimbal joint and a slew ring for connecting the upper end of the tripper device 17 to the second frame 21 of the cross conveyor 20. The gimbal joint can be comprised of one or more pivot pins for providing a multiple axis pivotable and rotatable connection between the upper end of the tripper device 17 and the second frame 21 of the cross conveyor 20. When configured as the combination of the gimbal joint and the slew ring, the tripper connector apparatus 70 may be configured to permit a rotatable connection about three different axes (e.g. x, y, and z axes, or length, height and depth axes) between the upper end of the tripper device 17 and the second frame 21 of the cross conveyor 20. The tripper connector apparatus 70 may be configured to additionally include a roller table or sliding table. The roller table or sliding table can include rollers 75 or other moveable element that can be configured to allow the upper end of the tripper device 17 to translate along the length L of the second frame 21 of the cross conveyor 20. The length L of the second frame of the cross conveyor 20 can extend in a direction that is perpendicular to or transverse to the height of the second frame 21 of the cross conveyor 20. For instance, the length L can extend from the first end 23 of the second frame 21 to the second end 25 of the second frame 21 about which the second belt 24 moves and the upper end of the tripper device can be translatable via rollers 75 along a path of movement that is substantially parallel to this length L or is generally aligned with a portion of this length L.

In some embodiments, the tripper connector apparatus 70 may be configured to include a roller table, a slew ring, and one or more pivot pins for providing a multiple axis pivotable and rotatable connection between the upper end of the tripper device 17 and the second frame 21 of the cross conveyor 20. For instance, the tripper connector apparatus 70 may include a first pin 74 that defines a first axis that extends horizontally or substantially horizontally (e.g. has no inclination or declination or is angled to decline or incline between 0° and 5° or between 0° and) 10°. The first pin 74 or each first pin of an aligned set of first pins may be a pin element such as an elongated member, a rod, a shaft, or beam, bolt or a type of elongated metal element that may adequately function as an axis of rotation to provide a rotatable connection between the upper end of the tripper device 17 and the second frame 21 of the cross conveyor 20. The first pin 74 may extend through at least one arm of a frame of the tripper device and also pass through one or more elements of the second frame 21 of the cross conveyor 20. The first pin 74 or a set of aligned first pins 74 may define a first axis of rotational movement about a horizontal or substantially horizontal axis (e.g. an axis having no inclination or declination or is angled to decline or incline between 0° and 10° or 0° and 5°) such that the cross conveyor 20 is vertically adjustable or pivotable about the horizontal axis defined by the first pin 74 or set of aligned first pins relative to the upper end of the tripper device 17.

The tripper connector apparatus 70 may also include a second pin 76 or a set of aligned second pins that define a second horizontal axis or substantially horizontal axis (e.g. an axis having no inclination or declination or is angled to decline or incline between 0° and 5° or between 0° and 10°) of rotation. Each second pin may be a pin element such as a rod, shaft, beam, bolt, or elongated member connected between the tripper device frame and the second frame 21 of the cross conveyor 20. The second substantially horizontal axis defined by the second pin 76 may be an axis that is perpendicular or substantially perpendicular (e.g. is perpendicular or within 10° of being perpendicular) to the first axis. For instance, if the first pin 74 and second pin 76 are each a solitary elongated pin having a length defining the first and second axes, the length of the first pin 74 may extend in a direction that is substantially perpendicular to the direction along which the length of the second pin 76 extends. The upper end of the tripper device 17 may be connected to the frame 21 of the cross conveyor such that the cross conveyor 20 is vertically tiltable or is pivotable relative to the upper end of the tripper device 17 about the second substantially horizontal axis defined by the second pin 76 or aligned set of second pins 76. It should be appreciated that the first pin and second pin 74, 76 (or set of aligned first pins and set of aligned second pins) may be configured to define a gimbal joint between the upper end of the tripper device 17 and the frame 21 of the cross conveyor 20.

A slew ring 77 or other type of rotatable connector may also be positioned between the upper end of the tripper device 17 and the frame 21 of the cross conveyor 20 to provide a rotatable connection between the upper end of the tripper device 17 and the frame 21 of the cross conveyor 20. The slew ring 77 can be above, below, or between the gimbal joint that may be defined by the one or more first pins 74 and one or more second pins 76. The slew ring 77 can define a rotatable connection about a vertical axis or substantially vertical axis such that the cross conveyor 20 may be rotatable relative to the upper end of the tripper device 17 about a vertically extending axis (e.g. an axis extending vertically from the ground on which the tracks 14, 22 are positioned to the sky, an axis that extends from the ground at an angle of between 80° and 100°, or an axis that extends vertically such that it is substantially perpendicular (e.g. within 10° of being perpendicular) to the first and second substantially horizontal axes defined by the first and second pins 74, 76) via the slew ring 77. It should be appreciated that the substantially vertical axis may be an axis that extends linearly and upwardly at an angle of 90° relative to the ground or be an axis that extends upwardly and linearly along an angle of between 80° and 100° relative to the ground.

The rotatable connection provided via the slew ring 77 or other type of rotatable connector may be configured so that rotation about the substantially vertical axis is limited (e.g. is less than 360° about the axis). For example, the rotational connection defined by the slew ring 77 may permit rotation about the substantially vertical axis only along a pre-defined path that is less than a full rotation about the substantially vertical axis, such as 45° of rotation or 90° of rotation.

The tripper device 17 can be rotatable relative to the cross conveyor 20 via the slew ring 77. The tripper device 17 can also be pivoted or tilted relative to the cross conveyor 20 via the first and second horizontal axes defined by the at least one first pin 74 and at least one second pin 76. The tripper device 17 can also be translated along the length of the cross conveyor via the roller table.

The tripper connector apparatus 70 may be configured so that the upper end of the tripper device is connected to the second frame 21 of the cross conveyor 20 so that material is fed off the upper terminal end of the tripper device 17 via movement of the first belt about the first and second first belt path segments 16a, 16b and is fed onto the second belt 24 of the cross conveyor 20 for transport. Arms, structures, or other frame elements may extend from the tripper device 17 below the upper end pulley 18 for providing the connection between the upper end of the tripper device 17 and the frame 21 of the cross conveyor via the first and second pins 74, 76 and the slew ring 77. The tripper connector apparatus 70 may be configured so that the upper end pulley 18 is positioned above the second belt 24, or is positioned to “float” above the second belt 24 for feeding material onto the second belt 24 while maintaining alignment of the first belt 16 moving about the tripper device 17 with the first frame of the mobile bridge conveyor 10.

The distribution of weight being supported by the first frame 11 of the mobile bridge conveyor 10 and the second frame 21 of the cross conveyor 20 can be controlled or adjusted by use of at least one counterweight 81 that is moveably connected to the tripper connector apparatus 70 and is moveable relative to a point of direct mechanical connection between the upper end of the frame of the tripper device 17 and the second frame 21 of the cross conveyor 20. The movement of the counterweight 81 can adjust the extent of the load (e.g. weight) of the tripper device that is distributed to and supported by the second frame 21 of the cross conveyor 20. Motion of the counterweight 81 away from the connection point between the frame of the tripper device 17 and second frame 21 of the cross conveyor can cause more of the load of the tripper device 17 to be distributed to the second frame 21 and less of the weight of the tripper device 17 to be supported by the first frame 11 of the mobile bridge conveyor 10. Movement of the counterweight closer to the connection point between the frame of the tripper device 17 and second frame 21 of the cross conveyor 20 can cause less of the load of the tripper device 17 to be supported by the second frame 21 so that more of that load is supported by the first frame 11 of the mobile bridge conveyor 10. A controller can be configured to cause an actuator connected to the counterweight 81 to actuate to move the counter weight 81 close to the connection point or farther from the connection point to adjust the amount of weight distributed to the first and second frame 11 and 21 to meet a particular set of operational requirements for reducing or increasing the load of the tripper device 17 distributed to the mobile bridge conveyor 10 and/or cross conveyor 20. The controller can actuate motion of the counterweight 81 based upon load related data received from sensors connected to the tripper device, the tripper connector apparatus 70 (e.g. pins 74 and/or 76, and/or table 75, etc.), the second frame 21, or other portions of the cross conveyor apparatus 20.

Motion of the counterweight 81 can adjust a distribution of the load of the tripper device 17 between the first and second frames 11 and 21 because the weight of the tripper device 17 is transferred to the first frame only via the first carriages 19 and to the second frame 21 via the tripper connector apparatus 70. For instance, when the tripper connector apparatus 70 connects the tripper device 17 to the cross conveyor 20, the tripper device is supported on the first frame 11 via the first carriages 19 of wheels adjacent the bottom end of the tripper device and is supported at the upper end of the tripper device via the second frame 21 of the cross conveyor. While member 52, lifting member 51 and second carriages 50 of wheels are attached between the first frame 11 of the mobile bridge conveyor 10 and the frame of the tripper device 17, they provide no support or almost no support (e.g. support less than 5% of the weight of the tripper device 17) to the tripper device 17 when the upper end of the tripper device 17 is attached to the tripper connector apparatus 70 and second frame 21 of the conveyor apparatus 20. The member 52 may be a bar, strut or other elongated member. The lifting member 51 may be a piston of a cylinder or other type of member that is adjustable when actuated to provide a force for lifting the upper end of the tripper device 17.

The weight distribution via motion of the counterweight 81 can occur because the tripper connector apparatus 70 is configured to transfer the weight from the upper end of the tripper device 17 to the second frame 21 of the cross conveyor 20 during operations and is located above the pivotal connections the lifting member 51 and angled member 52 have with the upper end of the tripper device 17. As such, the angled member 52 is able to freely rotate or move about the pivotal connection at its upper end 56 and provides no or almost no support to the tripper device 17. When a lifting member 51 is a hydraulic cylinder or other moveable device, the lifting member may also be configured so that the lifting member is freely extendable or retractable when the upper end of the tripper device is coupled to the frame 21 of the cross conveyor 20 during material transport operations and does not transfer any load from the tripper device 17 to the first frame 11 of the mobile bridge conveyor 10 because the lifting member 51 is unloaded (e.g. at low pressure or no pressure) during material transport operations. As discussed more fully below, the lifting member can be adjusted to an actuated position to provide a lifting force when the tripper device 17 is uncoupled from the cross conveyor 20 for maintenance or other non-material transport operations. Since the lifting member 51 and member 52 can be configured to provide no support or almost no support to the tripper device 17, motion of the counterweight can affect the extent to which weight is distributed from the tripper device 17 to the second frame 21 via the tripper connector apparatus 70.

A hopper or other guide member may be attached to the second frame 21 of the cross conveyor 20 and be sized and configured to guide material moved off the first belt 16 via the upper end of the tripper device 17 so that the material flows onto the second belt 24 for further material transport. The hopper or other guide member may define a tube, duct, conduit, or an annular structure for guiding the material being fed via the tripper to the second belt for stacking in a pile or otherwise transporting the material. A chute may also be attached to the frame of the tripper device 17 adjacent the upper end pulley 18 to direct the material down to the second belt 24 of the cross conveyor 20. The chute may be positioned to direct the material to the hopper for feeding the material onto the second belt 24.

In some embodiments, an adjustment mechanism 60 may also be connected between the second frame 21 of the cross conveyor and the tripper connector apparatus 70 to facilitate the centering and alignment of the tripper device 17 with first frame 11 of the mobile bridge conveyor 10 so that the first belt 16 stays aligned and does not become misaligned. In other embodiments, no such adjustment mechanism 60 may be needed. The adjustment mechanism can be one or more hydraulic cylinders or other mechanisms that may be configured to adjust a position of the upper end of the tripper device 17.

For instance, the adjustment mechanism 60 may include a hydraulic cylinder or other movement device that is moveably attached to the connector apparatus 70 for movement of the connector apparatus 70 for centering the upper end pulley 18 of the tripper device 17 so that the upper end of the tripper device 17 is properly centered with the first frame 11 of the mobile bridge conveyor 10 so that the first belt is properly aligned and will train properly. A hopper positioned between the tripper device and the second belt 24 can be elongated and positioned such that the hopper can guide material from the upper end pulley 18 as it moves along the length of the second belt 24. The hopper can be sized and configured so that it can receive material from the upper end of the pulley 18 throughout the entire path of travel the upper end pulley 18 is permitted to move along via movement of the connector apparatus 70 so that the hopper can guide the material from the tripper device to the second belt while the upper end pulley of the tripper device moves via the connector apparatus to center the upper end pulley 18 so that it is properly centered with the first frame 11 of the mobile bridge conveyor 10.

The adjustment mechanism 60 may have a first proximate end immovably affixed or pivotally coupled to the second frame 21 of the cross conveyor and an extendable and retractable second end that is immovably affixed or pivotally affixed to the tripper connector apparatus 70 or portion of the frame of the tripper device 17 for adjusting a position of the connection apparatus 70 and upper end pulley 18 of the tripper device 17. A roller table that includes rollers 75 may be included within the tripper connector apparatus 70 and coupled to the second frame 21 of the cross conveyor 20 for facilitating such motion so that extension or retraction of a moveable leg 61 of the hydraulic cylinder causes at least a portion of the tripper connector apparatus 70 to move along the rollers 75 relative to the second frame 21 of the cross conveyor 20 for adjusting a position of the upper end pulley 18 relative to the first frame 11 of the mobile bridge conveyor 10 to center the upper end of the tripper device 17 over the first frame 11 of the mobile bridge conveyor 10.

The extension and retraction of the leg 61 of the adjustment mechanism 60 may be a path of direction that is transverse to the length of the first belt 16 or is substantially perpendicular to the length of the frame 11 of the mobile bridge conveyor 10. As such, the extension and retraction of the leg 61 of the adjustment mechanism 60 may be a path of direction that is parallel to or in alignment with the direction about which the second belt 24 moves.

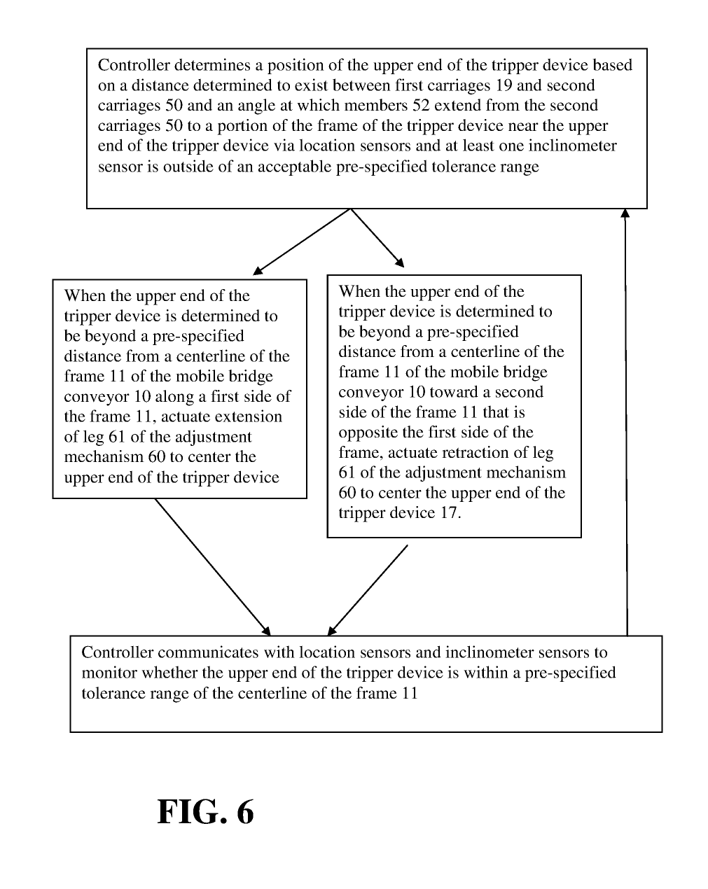

As may be appreciated from the exemplary method illustrated in FIG. 6, actuation of the adjustment mechanism 60 for providing a centering translation motion to the upper end of the tripper device 17 may be provided via a controller communicatively connected to sensors attached to different elements of the tripper device 17 and cross conveyor 20. The controller controlling actuation of the adjustment mechanism 60 may be a computer device having a processor communicatively connected to memory and a transceiver unit for wirelessly communicating with other elements such as sensors and the cylinder 60. The transceiver unit can also be configured for facilitating communication via a wired transmission path or a transmission path utilizing both wired and wireless transmission path segments. The controller may be a second controller or may be the same controller that also controls movement of the mobile bridge conveyor 10 and cross conveyor 20 via tracks 14 and 22.

Position sensors or other sensors may be attached to the first and second moveable carriages 19, 50 having one or more wheels. Additionally, an inclinometer sensor may be attached to an angled member 52 such as a lever, strut, or beam that extends form the second carriage 50 to the upper end of the tripper device 17 and has an upper end 56 pivotally attached to the upper end of the tripper. The pivotal connection of the member 52 to the tripper device 17 at its upper end 56 can be provided via a spherical pin attachment such that the members 52 are pivotal upwards, downwards, and sidewardly in opposite directions. For instance, the members 52 can move sidewardly away from the mobile bridge conveyor 10 and also move sidewardly toward the center of the mobile bridge conveyor 10. When the inclinometer detects a sideward motion of one or more of the members 52 away from the mobile bridge conveyor 10, this can indicate the first belt 16 is no longer centered along the first frame 11 due to motion of the upper end of the tripper device 17 and/or cross conveyor 20 and that the upper end of the tripper device 17 and/or the cross conveyor 20 needs to be moved to center the first belt 16 for alignment purposes.

During operation and due to the connection between the upper end of the tripper device 17 and the cross conveyor 20 provided by the tripper connector apparatus 70, the member 52 may not transfer any weight to the first frame 11 of the mobile bridge conveyor 10 or otherwise support the tripper device 17. Thus, the angle at which this member 52 extends from the second carriage to the upper end may be detected by the inclinometer sensor for use in determining where the upper end of the tripper device 17 is located relative to the second belt 24 of the cross conveyor 20.

Additionally, it is contemplated that some embodiments may also utilize sensors attached to the first and second carriages 19, 50 to identify the locations of these carriages or may otherwise be used to determine a distance between the first and second carriages 19 and 50 and a location of the first and second carriages 19, 50 relative to the positions of the first and second ends 12, 13 of the first frame via the sensors attached to the first frame 11. That distance, the positions of the first and second carriages 19, 50, the positions of the first and second ends 12, 13 as well as the angle of inclination of member 52 can be used to determine a position of the upper end of the tripper device 17. If the position is found to be outside a pre-specified tolerance range of a mid-point location of the second belt 24 or a midpoint location of the first belt 16 moving along idlers of the first frame 11, the controller may actuate the adjustment mechanism 60 to adjust a lateral position of the upper end of the tripper device 17 so that the tripper device is positioned centrally above the second belt 24 and first frame 11. Such motion may be a retraction or extension of leg 61 depending on the determined location of the upper end of the tripper device 17 based on data from the sensors attached to the member 52 and carriages 19, 50.

The use of the one or more inclinometer sensors 52 can be used in combination with the GPS sensors for providing redundancy for controlling movement of the cross conveyor 20 and mobile bridge conveyor 10 so that the frames of both devices do not contact each other during operations in such a way that damage could result from such contact. The redundancy provided by these sensors can provide increased reliability and provide redundant measuring related to identifying how close the frame of the cross conveyor 20 is to the first frame 11 of the mobile bridge conveyor 10 and vice versa. This can help prevent accidents or undesired crashes between the cross conveyor 20 and the mobile bridge conveyor 10.

Sensors attached to the first set of carriages 19 that identify a location of these carriages can also be utilized to help actuate adjustment of the position of the head pulley of the mobile bridge conveyor to ensure the first belt is properly aligned and centered. A controller can receive the location information of the first set of carriages as well as positioning information for the first and second ends 12 and 13 of the first frame 11 of the mobile bridge conveyor 10 to determine whether an adjustment to the height of the head pulley is necessary and send a signal to the actuator to adjust the position of the head pulley of the mobile bridge conveyor to maintain a centered position of the first belt 16 as it travels along a path defined by the first frame 11 and tripper device 17.

The tripper device 17 may be uncoupled from the frame 21 of the cross conveyor 20. When such uncoupling occurs, one or more hydraulic cylinders, struts, or other lifting members 51 attached between each second carriage 50 and the frame of the tripper device 17 supporting or defining the first inclined path segment 16a of the first belt 16 path of movement may be actuated to keep the upper end of the tripper device 17 elevated at a desired position. Each lifting member 51 may be pivotally coupled at a first end 54 to a respective second carriage 50 at a respective side of the first frame 11 and a second upper end 57 to the frame of the tripper device 17 at a respective side of the tripper device so that the length of the lifting member 51 is adjusted via retraction or extension of a portion of the lifting member (e.g. a piston of a hydraulic cylinder) to position the upper end of the tripper device at a desired elevation. The one or more lifting members 51 can be actuated to lift the tripper device frame out of connection with the tripper connector apparatus to uncouple the tripper device 17 from the second frame 21 of the cross conveyor to separate the tripper device 17 from the cross conveyor 20. Such uncoupling also acts to uncouple the cross conveyor 20 from the mobile bridge conveyor 10. The lifting member 51 may also be utilized during maintenance of the tripper device 17 or for other purposes when the tripper device 17 is uncoupled from the cross conveyor 20 when material transporting via motion of the first and second belts 16 and 24 is no longer being performed or is desired to be performed.

A contractor or other entity may provide a conveying system utilizing one or more embodiments of the conveyor apparatus 1. For instance, the contractor may receive a bid request for a project related to designing a system for stacking material or may offer to design such a system. The contractor may then provide a mobile bridge conveyor 10 and a cross conveyor 20. The contractor may provide such devices by selling those devices or by offering to sell those devices. The contractor may provide embodiments that are sized and configured to meet the design criteria of a client or customer. The contractor may subcontract the fabrication, delivery, sale, or installation of a component of any of the devices or of other devices to provide such devices. The contractor may also survey a site and design or designate one or more storage areas for stacking the material. In addition to providing a mobile bridge conveyor and a cross conveyor, the contractor may also provide overland conveyors, overland trippers, reclaimers, mobile hoppers or other devices used in material transport operations for stacking or reclaiming material. The contractor may also maintain, modify or upgrade the provided devices. The contractor may provide such maintenance or modifications by subcontracting such services or by directly providing those services.

It should be appreciated that embodiments of the conveyor apparatus, conveyor system, and tripper connector apparatus may be made to meet different sets of design criteria. For instance, a third set of wheel carriages may be included between the first and second sets of carriages 19, 50 for moveably coupling the tripper device 17 to the frame 11 of the mobile bridge conveyor 10. Sensors such as location sensors or distance measuring sensors may be attached to these middle carriages and provide a further reference point to the controller for determining when to actuate adjustment mechanism 60 for adjusting a position of the upper end of the tripper device to be in better alignment with a center of the frame 11 of the mobile bridge conveyor 10 to ensure the first belt 16 is in alignment as it moves along a path between the frame 11 of the mobile bridge conveyor 10 and the tripper device 17. As yet another alternative, the second carriage 50, lifting member 51 and member 52 may be the middle set of carriages and other elements and a front set of wheels for the tripper device may be provided for moveably coupling the tripper device frame to the frame 11 of the mobile bridge conveyor 10 so that the second carriage 50 of wheels is positioned between the first carriages 19 and front set of carriages. The middle set of carriages in either variation may be configured to connect to rails on the frame 11 of the mobile bridge conveyor to help laterally constrain the tripper device 17 to the frame 11 for aiding the alignment of the tripper device 17 with the frame 11 of the mobile bridge conveyor 10.

As yet another example, the adjustment mechanism 60 could be omitted in some embodiments. For those embodiments, the second set of carriages 50 could be configured to rigidly grip the rail of the first frame to rollably constrain the tripper device 17 to the rails of the first frame 11. Additionally, each member 52 could be rigidly pivotally coupled between the second carriage 50 and the frame of the tripper device 17 so that no sideward movement of the members 52 occurs and only downward and upward motion of the upper end of the tripper device occurs via pivotal movement of the member 52 (e.g. the pivotal connection to the upper end of the frame of the tripper device is via a cylindrical horizontally extending pivot pin and not a spherical pin). Such a configuration can help restrain the upper end of the tripper device 17 and the tripper connector apparatus 70 to be lie centered over the first belt 16 of the mobile bridge conveyor 10. Each member 52 connected to a respective second carriage 50 can hold the upper end of the tripper device 17 over the center of the first belt 16 and first frame 11 during adjustable movement of the cross conveyor 20. The rollers 75 of the roller table can permit movement of the second frame 21 relative to the tripper device 17 to translate beneath the upper end of the tripper device 17 so that rotatable and tilting motion of the cross conveyor 20 relative to the tripper device 17 can occur while the cross conveyor 20 is coupled to the tripper device 17 via the tripper connector apparatus 70.

As yet another example, the size, length, width, and height of the cross conveyor 20 and mobile bridge conveyor 10 and tripper device 17 and frames for these devices may be any of a number of different dimensions to meet a particular set of design criteria that may include factors such as cost, capacity requirements, as well as other objectives or goals. As yet another example, the tracks of the cross conveyor 20 and mobile bridge conveyor may be rotatable tracks that rotate to aid steering of movement or may be tracks that are affixed and non-rotatable and rotate due to differences in rates of rotation by the different tracks. As yet another example, it is contemplated that for some embodiments the tracks could be replaced with wheels or other moveable members.

While certain exemplary embodiments of a conveyor apparatus and a tripper connector apparatus and methods of making and using the same have been shown and described above, it is to be distinctly understood that the invention is not limited thereto but may be otherwise variously embodied and practiced within the scope of the following claims.

What is claimed is:

1. A conveyor apparatus comprising:
a mobile bridge conveyor having a first frame that is attached to at least one first moveable member such that the first frame is moveable along ground and a first belt moveably connected to the first frame for movement along a path of travel that is at least partially supported by the first frame, the first frame having a first end and a second end opposite the first end, the first belt being moveable to convey material in at least one direction;
a cross conveyor having a second frame attached to at least one second moveable member such that the second frame is movable along the ground, a second belt moveably attached to the second frame, the second belt being moveable for conveying material in at least one direction;
a tripper device moveably attached to the first frame of the mobile bridge conveyor such that the tripper device is moveable between the first end and the second end of the first frame, an upper end of the tripper device also moveably attached to the second frame of the cross conveyor via a tripper connector apparatus such that the cross conveyor is rotatable about at least one substantially vertical axis relative to the upper end of the tripper device and the cross conveyor is tiltable about at least one substantially horizontal axis relative to the tripper device.

2. The conveyor apparatus of claim 1 wherein the tripper device is moveably attached to the first frame of the mobile bridge conveyor such that the path of travel the first belt moves about comprises a first inclined path segment extending from adjacent the first frame to the upper end of the tripper device and a second declined path segment that extends from the upper end of the tripper device to adjacent the first frame, the first and second path segments being defined by the tripper device, and wherein the first belt moves along the first and second path segments as the first belt is moved from the first end of the first frame to the second end of the first frame to transport material.

3. The conveyor apparatus of claim 1 wherein the tripper connector apparatus comprises:
a first connection between the upper end of the tripper device and the second frame of the cross conveyor;
a second connection between the upper end of the tripper device and the second frame of the cross conveyor;
a third connection between the upper end of the tripper device and the second frame of the cross conveyor;
the first connection being defined by at least one first pin defining a first substantially horizontal axis of rotation about which the cross conveyor is moveable relative to the upper end of the tripper device;
the second connection being defined by at least one second pin defining a second substantially horizontal axis of rotation about which the cross conveyor is moveable relative to the upper end of the tripper device, the second substantially horizontal axis being substantially perpendicular to the first substantially horizontal axis; and
the third connection being defined by a rotatable connector such that the cross conveyor is moveable relative to the upper end of the tripper device about a substantially vertical axis that is substantially perpendicular to the first and second substantially horizontal axes.

4. The conveyor apparatus of claim 3 wherein the first substantially horizontal axis is a horizontal axis, the second substantially horizontal axis is a horizontal axis that is transverse to the first horizontal axis, and the substantially vertical axis is a vertical axis that is perpendicular to the first and second horizontal axes.

5. The conveyor apparatus of claim 3 wherein the rotatable connector of the third connection is comprised of a slew ring.

6. The conveyor apparatus of claim 3 wherein the first substantially horizontal axis defined by the at least one first pin extends in a direction that is perpendicular to the direction at which the second substantially horizontal axis defined by the at least one second pin extends.

7. The conveyor apparatus of claim 6 wherein the first substantially horizontal axis is defined by a single first pin and the second substantially horizontal axis is defined by a single second pin.

8. The conveyor apparatus of claim 3 wherein the first substantially horizontal axis is a linear axis that is inclined or declined between 0° and 10°, the second substantially horizontal axis is a linear axis that is inclined or declined between 0° and 10°, and the substantially vertical axis is a linear axis that is inclined or declined relative to the ground between 80° and 100°.

9. The conveyor apparatus of claim 1 comprising:
at least one first sensor attached to one of the cross conveyor and the tripper device and at least one second sensor attached to the tripper device and at least one controller communicatively connected to the first and second sensors;
a first adjustment mechanism having a moveable leg attached between the second frame of the cross conveyor and the upper end of the tripper device, the moveable leg being moveable to adjust a position of the upper end of the tripper device for centering the upper end of the tripper device relative to the first frame.

10. The conveyor apparatus of claim 9 wherein the controller is communicatively connected to the first adjustment mechanism to actuate movement of the moveable leg based on data the controller receives from the first and second sensors.

11. The conveyor apparatus of claim 10 wherein the tripper device is comprised of a tripper device frame having a first set of wheels attached to the first frame and a second set of wheels attached to the first frame, each first sensor attached to the first set of wheels and each second sensor attached to the second set of wheels.

12. The conveyor apparatus of claim 11 wherein the tripper device further comprises at least one member extending from each second set of wheels to a position adjacent the upper end of the tripper device, a third sensor attached to each member extending from the second set of wheels to adjacent the upper end of the tripper device, each third sensor communicatively connected to the controller, the controller actuating movement of the moveable leg based on data the controller receives from the first and second sensors and each third sensor.

13. A tripper connector apparatus for moveably attaching a cross conveyor to a tripper device of a mobile bridge conveyor, comprising:
a first connection between the tripper device positioned on a frame of the mobile bridge conveyor and the cross conveyor;
a second connection between the tripper device and the cross conveyor;
a third connection between the tripper device and the cross conveyor;
the first connection being defined by at least one first pin defining a first substantially horizontal axis of rotation about which the cross conveyor is moveable relative to an upper end of the tripper device;
the second connection being defined by at least one second pin defining a second substantially horizontal axis of rotation about which the cross conveyor is moveable relative to the upper end of the tripper device, the second substantially horizontal axis being substantially perpendicular to the first substantially horizontal axis; and
the third connection being defined by a rotatable connector such that the cross conveyor is rotatable relative to the upper end of the tripper device about a vertical axis that is substantially perpendicular to the first and second substantially horizontal axes.

14. The tripper connector apparatus of claim 13 wherein the rotatable connector of the third connection comprises a slew ring.

15. The tripper connector apparatus of claim 13 wherein the first substantially horizontal axis is defined by a single first pin and the second substantially horizontal axis is defined by a single second pin.

16. The tripper connector apparatus of claim 13 wherein the first substantially horizontal axis defined by the at least one first pin extends in a direction that is perpendicular to the direction at which the second substantially horizontal axis defined by the at least one second pin extends.

17. The tripper connector apparatus of claim 13 wherein the first substantially horizontal axis is a horizontal axis, the second substantially horizontal axis is a horizontal axis, and the substantially vertical axis is a vertical axis that is perpendicular to the first and second horizontal axes.

18. The tripper connector apparatus of claim 13 wherein the first substantially horizontal axis is a linear axis that is inclined or declined between 0° and 10°, the second substantially horizontal axis is a linear axis that is inclined or declined between 0° and 10°, and the substantially vertical axis is a linear axis that is inclined or declined relative to the ground between 80° and 100°.

19. A conveyor apparatus comprising:
a mobile bridge conveyor having a first frame that is attached to at least one first moveable member such that the first frame is moveable along ground, a first belt at least partially supported by the first frame, the first frame having a first end and a second end opposite the first end, the first belt being moveable to convey material in at least one direction;
a tripper device moveably attached to the first frame of the mobile bridge conveyor such that the tripper device is moveable between the first end and the second end of the first frame and the first belt of the mobile bridge conveyor being moveable about a portion of the tripper device;
a cross conveyor having a second frame attached to at least one second moveable member such that the second frame is movable along the ground, a second belt moveably attached to the second frame, the second belt being moveable for conveying material in at least one direction, the second frame of the cross conveyor being attached to an upper end of the tripper device via a tripper connector apparatus;
at least one first sensor attached to one of the tripper device and the cross conveyor and at least one second sensor attached to the tripper device;
at least one controller communicatively connected to the first and second sensors;
a tripper adjustment mechanism attached between the second frame of the cross conveyor and the upper end of the tripper device to moveably adjust a position of the upper end of the tripper device for centering the tripper device relative to the first frame;
the controller communicatively connected to the tripper adjustment mechanism to actuate movement of at least one moveable leg of the tripper adjustment mechanism based on data the controller receives from the first and second sensors for centering the tripper device relative to the first frame.

20. The conveyor apparatus of claim 19 wherein the tripper connector apparatus comprising:
a first connection between the tripper device and the cross conveyor;
a second connection between the tripper device and the cross conveyor;
a third connection between the tripper device and the cross conveyor;
the first connection being defined by at least one first pin defining a first substantially horizontal axis of rotation about which the cross conveyor is moveable relative to the tripper device;
the second connection being defined by at least one second pin defining a second substantially horizontal axis of rotation about which the cross conveyor is moveable relative to the tripper device, the second substantially horizontal axis being transverse to the first substantially horizontal axis; and
the third connection being defined by a rotatable connector such that the cross conveyor is rotatable relative to the upper end of the tripper device about a vertical axis that is substantially perpendicular to the first and second substantially horizontal axes; and
wherein the at least one first moveable member is comprised of a plurality of tracks or crawlers and the at least one second moveable member is comprised of a plurality of tracks or crawlers.
